(19) United States
(12) Patent Application Publication
(10) Pub. No.: US 2013/0016960 A1
(43) Pub. Date: Jan. 17, 2013

(54) Waterproof Camera

(71) Applicant: Te-Wei Yang, Yangmei City (TW)

(72) Inventor: Te-Wei Yang, Yangmei City (TW)

(73) Assignee: ALTEK CORPORATION, Hsinchu (TW)

(21) Appl. No.: 13/224,682

(22) Filed: Sep. 2, 2011

(30) Foreign Application Priority Data
Jul. 14, 2011 (TW) 100125017

(51) Int. Cl. G03B 17/08

(52) U.S. Cl. 396/25

(57) ABSTRACT

A waterproof camera including an image capturing module, a shell and a plurality of control buttons. The image capturing module is provided for capturing an image, and further includes a lens, which is a prism type lens installed in the camera. The shell is provided for sealing and covering the whole camera, and includes a window component made of a transparent material and installed correspondingly to a position of image capturing module. The control buttons are arranged on the shell for controlling an operation of the camera and the control buttons are sealed with the shell to achieve the waterproof effect of the camera.

### CROSS-REFERENCE TO RELATED APPLICATION

This application claims priority from Taiwan Patent Application No. 100125017, filed on Jul. 14, 2011, the contents of which are hereby incorporated by reference in their entirety for all purposes.

### BACKGROUND OF THE INVENTION

1. Field of the Invention

The present invention relates to a waterproof camera, in particular to the waterproof camera having a shell without any holes or openable covers.

2. Description of the Related Art

At present, conventional cameras generally have transmitting ports or covers such as a battery cover, a memory slot, and a USB slot, so that the shell of a camera usually has many holes and gaps and the camera does not have a waterproof effect.

The conventional waterproof cameras usually achieve the waterproof effect by putting the whole camera into a waterproof box or a waterproof bag in order to use the camera in water. However, such application is troublesome, and the volume of the camera cannot be reduced effectively.

In addition, some waterproof cameras achieve the waterproof effect without requiring the use of the waterproof box or the waterproof bag, and these cameras generally seal the edges of the battery cover or memory cover by an elastic sealing material, so that the seams of the shell can be sealed to provide an enclosed body of the camera to achieve the waterproof effect. However, the elastic material has a concern of being worn out and needs to be replaced from time to time, thus causing inconvenience and wasting money. Furthermore, the leaking problem still exists, if the user forgets to close the cover properly during the operation of the camera in water, and the conventional waterproof cameras still cannot achieve a satisfactory waterproof effect, and these cameras may be damaged accidentally in some cases.

Therefore, it is an important and urgent subject for related manufacturers to provide a waterproof camera that can achieve a complete waterproof function to overcome the drawbacks of the prior art.

### SUMMARY OF THE INVENTION

In view of the aforementioned drawbacks of the prior art, it is an objective of the present invention to provide a waterproof camera to overcome the problems of the conventional waterproof cameras that require accessories for the waterproof function.

To achieve the aforementioned objective, the present invention further provides a waterproof camera, comprising an image capturing module, a shell and a plurality of control buttons. The image capturing module is provided for capturing an image and the image capturing module includes a lens which is a prism type lens installed in camera. The shell is provided for sealing and covering the whole camera, and the shell includes a window component made of a transparent material and installed correspondingly to a position of image capturing module. The control buttons are arranged on the shell for controlling an operation of the camera.

To achieve the objective of the present invention, the invention further provides a waterproof camera, comprising an image capturing module, a shell and a plurality of control buttons. The image capturing module is provided for capturing an image. The shell is provided for sealing and covering the whole camera and includes a window component made of a transparent material and installed correspondingly to a position of image capturing module. The control buttons are arranged on the shell for controlling an operation of the camera, and the control buttons and the shell are sealed with each other.

To achieve the objective of the present invention, the invention further provides a waterproof camera comprising an image capturing module, a shell and a plurality of control buttons. The image capturing module is provided for capturing an image. The shell is provided for sealing and covering the whole camera and includes a window component made of a transparent material and installed correspondingly to a position of image capturing module. The control buttons are arranged on the shell for controlling an operation of the camera. Wherein, the shell does not have any holes or openable covers, and the control buttons arranged on the shell and the window component made of the transparent material are sealed with the shell.

Preferably, a data transmission module is provided, and sealed and covered into the camera by the shell for outputting and inputting data via a wireless transmission.

Preferably, a wireless charging module is further provided, and sealed and covered inside the camera by the shell for receiving an external electric power via a wireless method to charge the camera.

In summation, the waterproof camera of the present invention has one or more of the following advantages.

(1) The waterproof camera of the present invention includes the shell without any holes or openable covers, not only achieving a waterproof effect, but also providing a dustproof effect.

(2) The waterproof camera of the present invention does not require any waterproof accessories such as the waterproof box to achieve the waterproof effect, so that it can achieve the effect of reducing the volume of the camera.

### BRIEF DESCRIPTION OF THE DRAWINGS

FIG. 1 is a block diagram of a waterproof camera in accordance with a preferred embodiment of the present invention;

FIG. 2 is a schematic view of a waterproof camera in accordance with a preferred embodiment of the present invention;

FIG. 3 is a schematic view of an image capturing module in accordance with a preferred embodiment of the present invention;

FIG. 4 is a rear view of a preferred embodiment of the present invention;

FIG. 5 is a rear view of another preferred embodiment of the present invention;

FIG. 6 is a schematic view of a data transmission module in accordance with a preferred embodiment of the present invention;

FIG. 7 is a schematic view of a wireless charging module in accordance with a preferred embodiment of the present invention; and

FIG. 8 is a schematic view of an application of a waterproof camera in accordance with a preferred embodiment of the present invention.

### DETAILED DESCRIPTION OF THE PREFERRED EMBODIMENTS

The technical characteristics and effects of the present invention will become apparent by the detailed description of preferred embodiments and the illustration of related drawings as follows. For simplicity, same numerals are used for representing respective elements respectively in the following preferred embodiments and drawings.

The camera of the present invention can be a portable electronic device having a photographic function such as a digital camera or a digital video camera. For simplicity, the portable electronic device of this preferred embodiment is a digital camera used for illustrating the technical characteristics of the present invention, but the invention is not limited to the digital camera only.

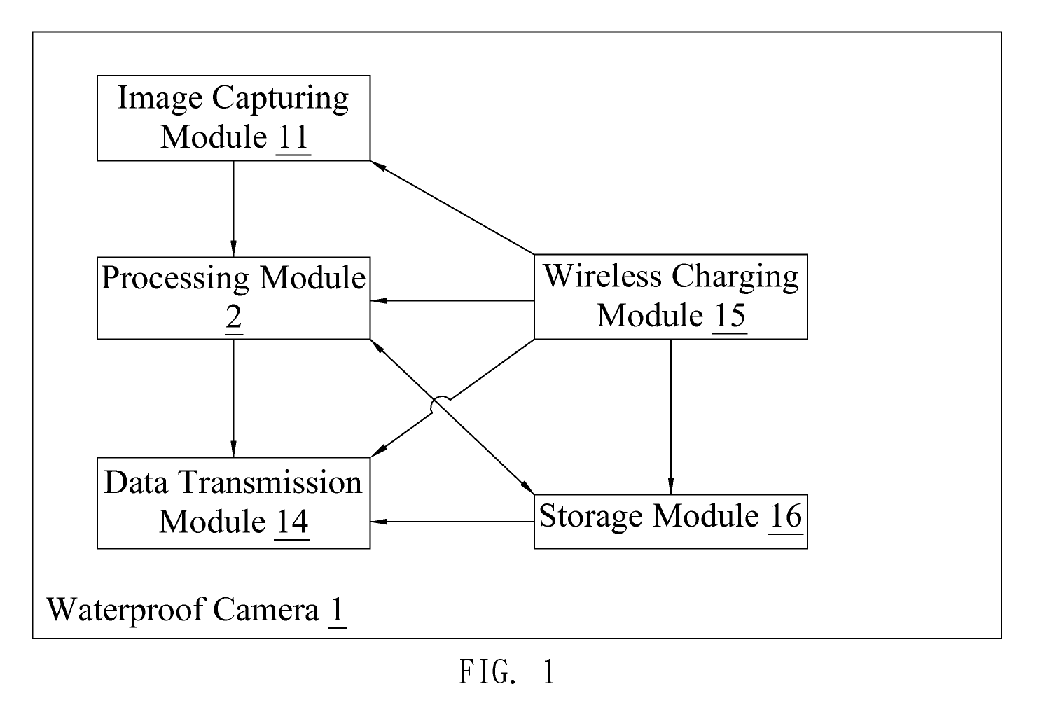

With reference to FIG. 1 for a block diagram of a waterproof camera in accordance with a preferred embodiment of the present invention, the waterproof camera 1 comprises a processing module 2, an image capturing module 11, a data transmission module 14, a wireless charging module 15 and a memory module 16. The processing module 2 is electrically coupled to the image capturing module 11, the data transmission module 14, the wireless charging module 15 and the storage module 16. The processing module 2 can be a central processing unit (CPU) or a micro-processing unit for controlling an operation procedure of the waterproof camera 1. The image capturing module 11 is provided for capturing an image. Wherein, the image capturing module 11 includes a lens and a light sensing component such as a complementary metal oxide semiconductor (CMOS) or a charge coupled device (CCD), an analog/digital circuit, and an image processor. The data transmission module 14 is provided for outputting or inputting data via a wireless transmission. The wireless charging module 15 is provided for receiving an external electric power via a wireless method to charge the camera. The storage module 16 is provided for storing an image, and the storage module 16 can be an embedded memory.

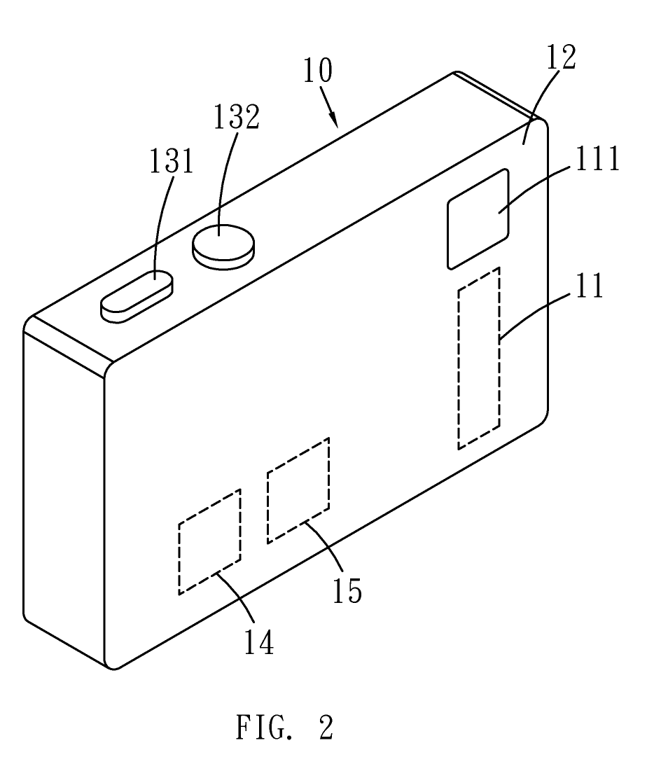

With reference to FIG. 2 for a schematic view of a waterproof camera in accordance with a preferred embodiment of the present invention, the waterproof camera comprises a main body 10, an image capturing module 11, a window component 111 made of a transparent material, a shell 12, a shutter button 131, a power button 132, a data transmission module 14 and a wireless charging module 15. The image capturing module 11 is provided for capturing an image. The shell 12 is provided for sealing and covering the main body 10 and the shell 12 includes a window component 111 made of a transparent material and installed correspondingly to a position of image capturing module of the image capturing module 11. The shutter button 131 is preferably arranged on the shell 12 for controlling the operation of a shutter of the camera. The power button 132 is preferably arranged on the shell 12 for controlling the power-on and power-off of the camera. The data transmission module 14 is sealed and covered inside the main body 10 by the shell 12. The wireless charging module 15 is sealed and covered inside the main body 10 by the shell 12. A display module (not shown in FIG. 1) is installed at the back of the main body 10 for displaying the images and the display module can be a liquid crystal display (LCD) or an LCD touch screen.

Wherein, the window component 111 made of the transparent material, the shutter button 131 and the power button 132 are sealed with the shell 12, so that the shell 12 has no hole or gap to achieve the waterproof effect.

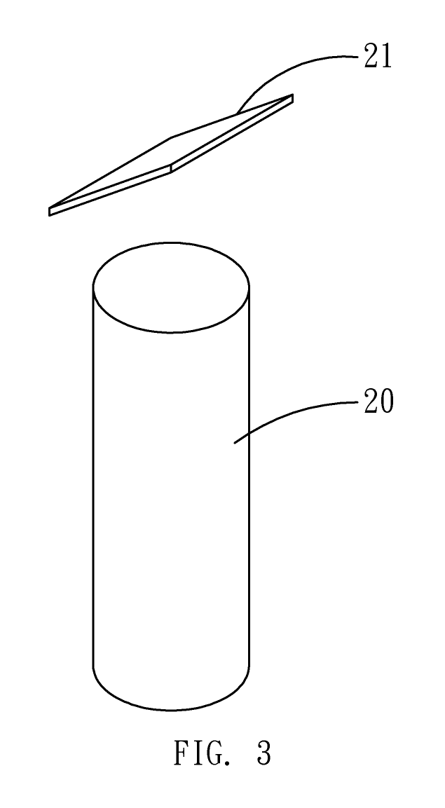

With reference to FIG. 3 for a schematic view of an image capturing module in accordance with a preferred embodiment of the present invention, the image capturing module comprises a lens 20 and a mirror 21. In this preferred embodiment, the lens 20 is preferably a prism type lens. When a user needs to adjust the focal length of the camera, the lens 20 will be extended or retracted with respect to the mirror 21 to achieve the effect of adjusting the focal length.

With reference to FIG. 2 together, the prism type lens is adopted in this preferred embodiment, so that the image capturing module 11 can be covered completely inside the main body 10 by the shell 12, and the mirror 21 reflects an image through the window component 111 made of the transparent material to the lens 20 in order to capture the image. Since the window component 111 made of the transparent material is sealed with the shell 12, the waterproof effect can be achieved.

It is noteworthy to point out that the prism type lens adopted in this preferred embodiment is provided for illustrating the invention only, but people ordinarily skilled in the art should understand that the present invention is not limited to such arrangement only, but any other equivalent methods can be used instead.

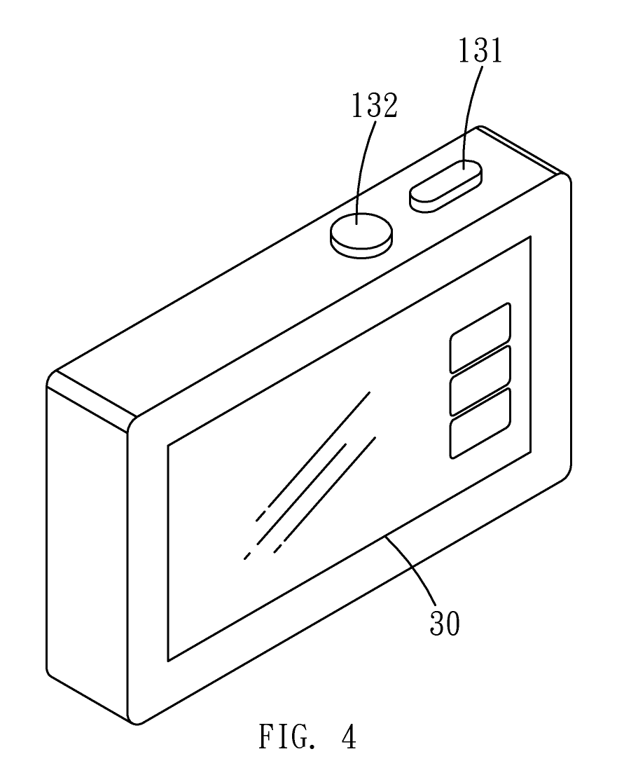

With reference to FIG. 4 for a rear view of a waterproof camera in accordance with a preferred embodiment of the present invention, the waterproof camera comprises an LCD touch screen 30, a shutter button 131 and a power button 132. This preferred embodiment adopts the LCD touch screen 30, so that the user can use the LCD touch screen 30 to carry out basic functions of the camera such as adjusting a focal length, browsing a photo, or turning on/off the flash light, and the user no longer requires additional control buttons for the operations of the camera.

Wherein, the LCD touch screen of this preferred embodiment is a resistive touch screen or a capacitive touch screen, depending on the application and design requirements.

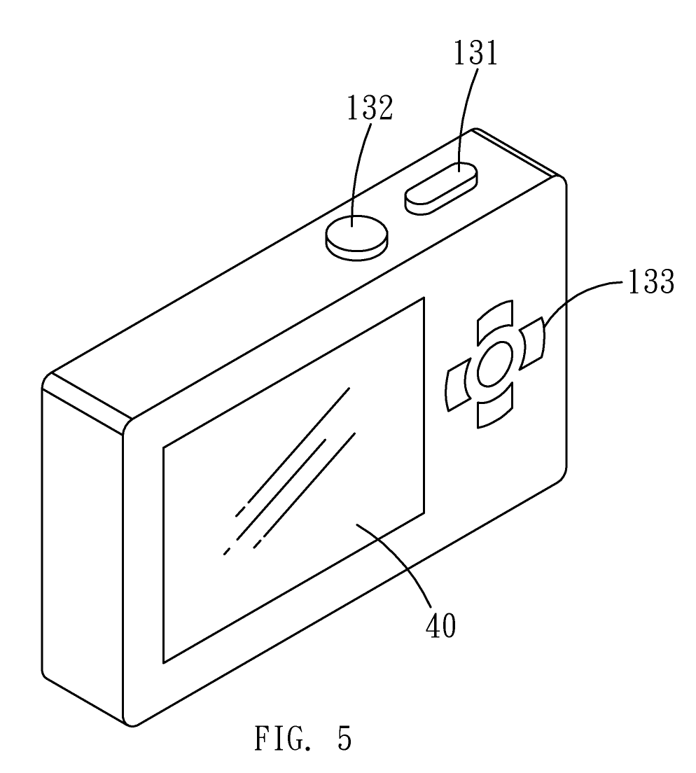

With reference to FIG. 5 for a rear view of a waterproof camera in accordance with another preferred embodiment of the present invention, the waterproof camera comprises an LCD screen 40, a shutter button 131, a power button 132 and a control button set 133. This preferred embodiment adopts the LCD screen 40, so that the user cannot operate the camera by the touch screen method, and requires an additional control button set 133 to carry out the basic functions of the camera, such as adjusting a focal length, browsing a photo, or turning on/off the flash light. Although this preferred embodiment cannot operate the camera by the touch control method, the control button set 133 and the shell 12 are completely sealed with each other to achieve the waterproof effect.

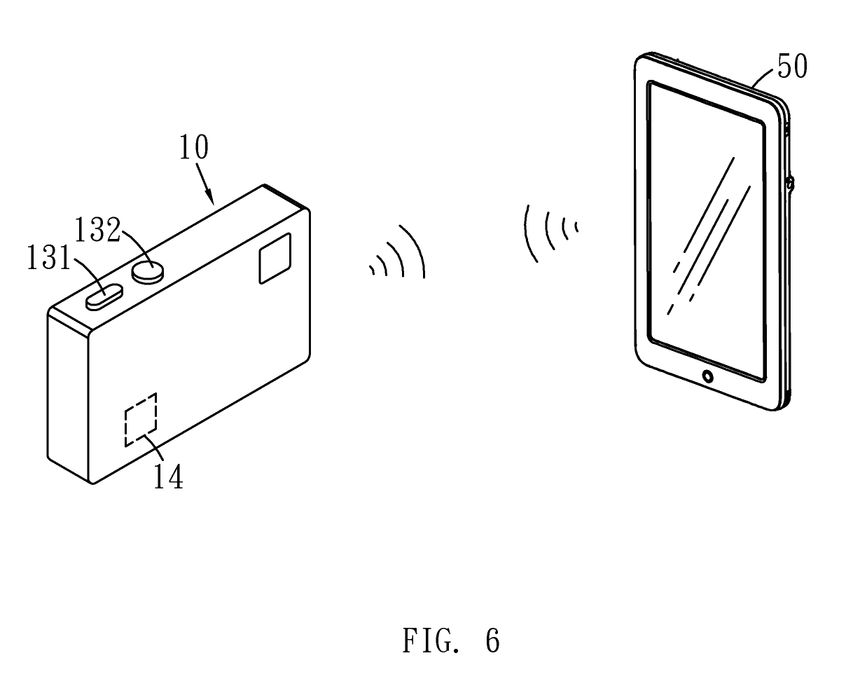

With reference to FIG. 6 for a schematic view of a data transmission module in accordance with a preferred embodiment of the present invention, a user can use the data transmission module 14 inside the main body 10 to output or input data via a wireless transmission. The data transmission module 14 can receive data from the electronic transmission device 50 via a wireless transmission or output data to the electronic transmission device 50. The electronic transmission device 50 can be any electronic transmission devices capable of transmitting data via the wireless transmission such as a computer, a tablet personal computer, a mobile phone, a smart phone or a personal digital assistant (PDA). For simplicity, the tablet personal computer is used as an example in this preferred embodiment for illustrating the technical characteristics of the present invention, but the invention is not limited to the tablet personal computer only. Since the user can output or input data via a wireless transmission, therefore the user no longer needs to transmit the image in the camera to the electronic transmission device by using a data transmission line anymore. The user simply transmits data via the wireless transmission module, and the invention can provide a convenient application.

Wherein, the data are transmitted via the wireless transmission method, and the data transmission module 14 is sealed and covered inside the main body 10 by the shell 12, so that the camera of the present invention does not require any components having a hole or a cover such as a USB hole or a memory card slot for data transmissions. In addition, the main body 10 has no hole, gap or openable cover, so that the camera of the present invention can achieve the waterproof effect.

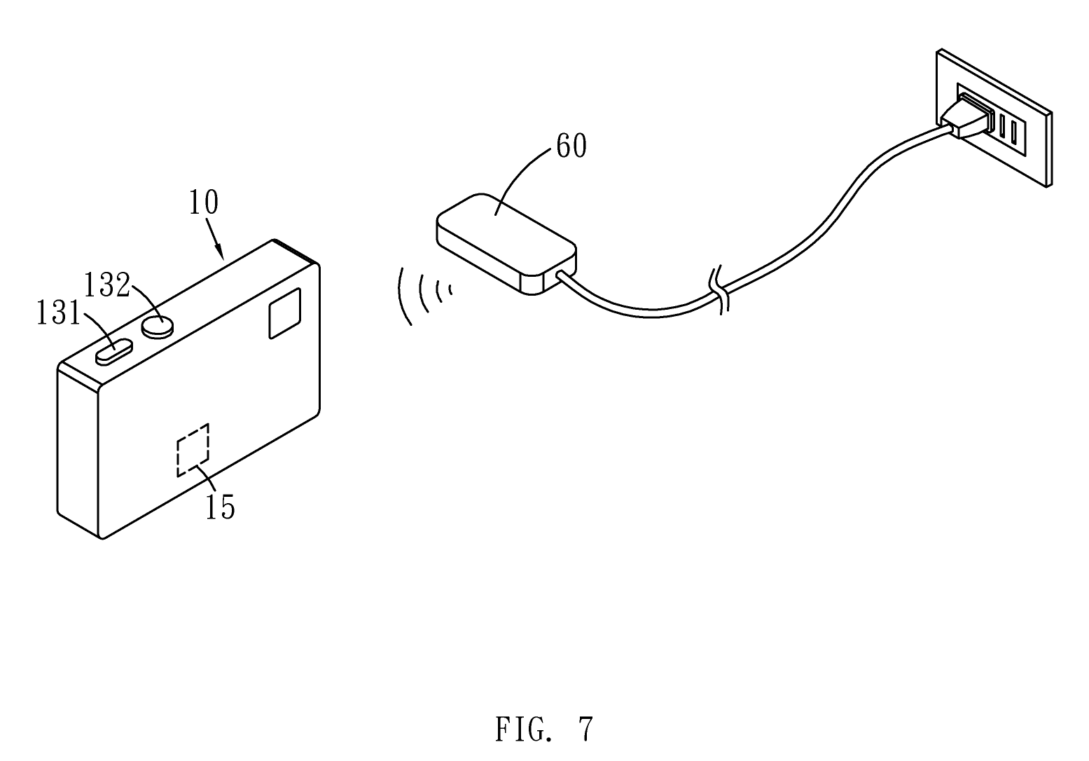

With reference to FIG. 7 a schematic view of a wireless charging module in accordance with a preferred embodiment of the present invention, the wireless charging module 15 is provided for receiving an external electric power from a power transmission device 60 via a wireless method to charge the camera. Since the user can charge the camera by the wireless charging method, therefore no charging cable is required for the wireless charging module to receive the electric power, and the present invention provides a more convenient application.

Wherein, the wireless charging method is adopted, and the wireless charging module 15 is sealed and covered inside the main body 10 by the shell 12, so that the camera of the present invention does not require any components having a hole or an openable cover such as a battery slot or a charging hole to charge the camera, and the main body 10 has no hole, gap or openable cover, and the present invention can achieve the waterproof effect.

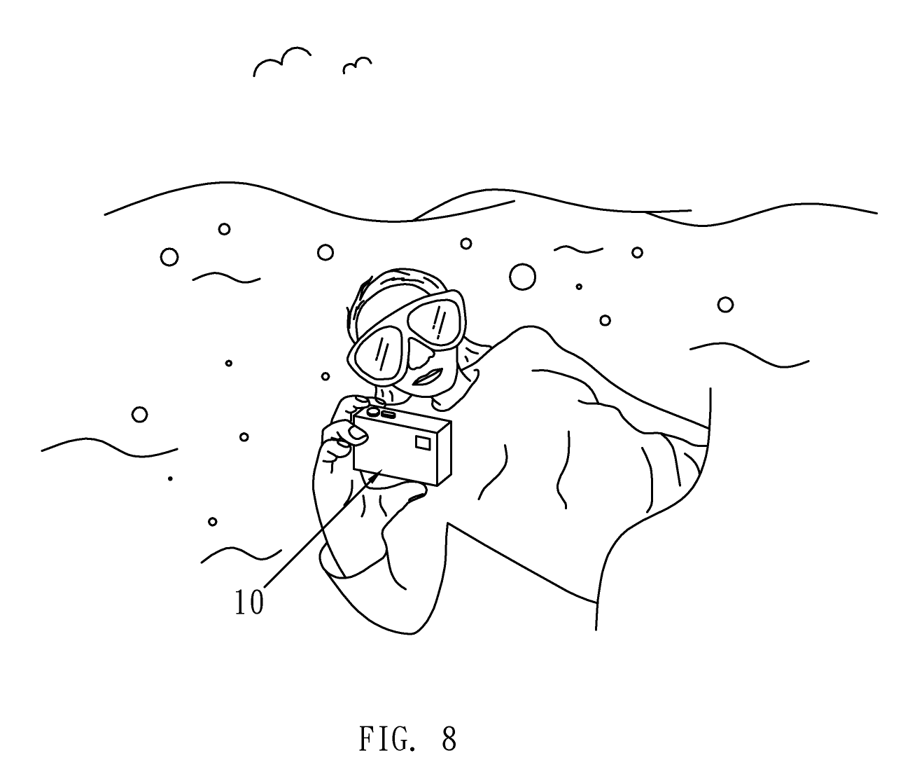

With reference to FIG. 8 for a schematic view of an application of a waterproof camera in accordance with a preferred embodiment of the present invention the present invention, a user is taking a picture by the waterproof camera in a snorkeling activity, and the user carries the main body 10 of the camera into water, wherein the camera has no hole, gap, or openable cover, so that no accessory equipment (such as a waterproof box or a waterproof bag) is required. The user just carries the camera directly into the water. The invention not only improves the convenience of using the camera, but also achieves the effect of reducing the volume of the camera.

In addition, the waterproof camera of the present invention can be used under water and in a rainy day, since the camera of the present invention without any holes, gaps or openable covers can prevent water from entering into the camera.

In summation of the description above, the waterproof camera of the present invention adopts the shell to cover the whole camera and a design without any holes or openable covers, so that the camera can achieve the waterproof effect. With the features of the shell of the present invention, tiny things such as dust cannot enter from holes or gaps into the camera, so that the camera also has the dustproof effect. In addition, the camera of the invention requires no accessory equipment (such as a waterproof box or a waterproof bag) to achieve the waterproof effect and it also can achieve the effect of reducing the volume of the camera.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

1. A waterproof camera, comprising:
an image capturing module capturing an image and including a mirror and a prism type lens installed in the waterproof camera, wherein the prism type lens is extended or retracted with respect to the mirror for adjusting a focal length of the waterproof camera;
a display module installed at the back of the waterproof camera for displaying the image;
a shell sealing and covering the whole waterproof camera and including a window component made of a transparent material and installed correspondingly to a position of the image capturing module; and
a plurality of control buttons arranged on the shell and controlling an operation of the waterproof camera.

2. The waterproof camera of claim 1, wherein the shell and the control buttons are sealed with each other.

3. The waterproof camera of claim 1, wherein the shell and the window component made of the transparent material are sealed with each other.

4. The waterproof camera of claim 1, further comprising a data transmission module sealed and covered inside the waterproof camera by the shell and provided for outputting or inputting data via a wireless transmission.

5. The waterproof camera of claim 1, further comprising a wireless charging module sealed and covered inside the waterproof camera by the shell and provided for receiving an external electric power via a wireless method to charge the waterproof camera.

6. A waterproof camera, comprising:
an image capturing module capturing an image and including a mirror and a prism type lens installed in the waterproof camera, wherein the prism type lens is extended or retracted with respect to the mirror for adjusting a focal length of the waterproof camera;
a display module installed at the back of the waterproof camera for displaying the image;
a shell sealing and covering the whole waterproof camera and including a window component made of a transparent material and installed correspondingly to a position of the image capturing module; and
a plurality of control buttons arranged on the shell and controlling an operation of the waterproof camera, and the control buttons and the shell being sealed with each other.

7. (canceled)

8. The waterproof camera of claim 6, wherein the shell and the window component made of the transparent material are sealed with each other.

9. The waterproof camera of claim 6, further comprising a data transmission module sealed and covered inside the waterproof camera by the shell for outputting or inputting data.

10. The waterproof camera of claim 6, further comprising a wireless charging module sealed and covered into the waterproof camera by the shell, for receiving an external electric power via a wireless method to charge the waterproof camera.

11. A waterproof camera, comprising:
an image capturing module capturing an image and including a mirror and a prism type lens installed in the waterproof camera, wherein the prism type lens is extended or retracted with respect to the mirror for adjusting a focal length of the waterproof camera;
a display module installed at the back of the waterproof camera for displaying the image;
a shell sealing and covering the whole waterproof camera and including a window component made of a transparent material and installed correspondingly to a position of the image capturing module; and
a plurality of control buttons arranged on the shell and controlling an operation of the waterproof camera;
wherein the shell does not have any holes or openable covers, and the control buttons arranged on the shell and the window component made of the transparent material are sealed with the shell.

12. (canceled)

13. The waterproof camera of claim 11, further comprising a data transmission module sealed and covered inside the waterproof camera by the shell for outputting and inputting data via a wireless transmission.

14. The waterproof camera of claim 11, further comprising a wireless charging module sealed and covered inside the waterproof camera by the shell and provided for receiving an external electric power via a wireless method to charge the waterproof camera.
